(19) United States
(12) Patent Application Publication
(10) Pub. No.: US 2026/0044033 A1
(43) Pub. Date: Feb. 12, 2026

(54) ELECTRONIC DEVICE

(71) Applicant: Advanced Semiconductor Engineering, Inc., Kaohsiung (TW)

(72) Inventors: Jr-Wei LIN, Kaohsiung (TW); Mei-Ju LU, Kaohsiung (TW)

(73) Assignee: Advanced Semiconductor Engineering, Inc., Kaohsiung (TW)

(21) Appl. No.: 18/795,933

(22) Filed: Aug. 6, 2024

(51) Int. Cl. G02F 1/13; G02F 1/313

(52) U.S. Cl. CPC G02F 1/1326; G02F 1/3135; G02F 1/3137

(57) ABSTRACT

An electronic device is provided. The electronic device includes a plurality of electronic components, a plurality of first waveguides, and a switch element. The first waveguides are disposed under the electronic components. The switch element is disposed under the electronic components and at an elevation different from the first waveguides, wherein the switch element is configured to optically connect a first one of the first waveguides to a second one of the first waveguides.

### BACKGROUND

### 1. Technical Field

The present disclosure relates generally to an electronic device.

### 2. Description of the Related Art

Currently, data transmission between active components (e.g., GPUs and CPUs) in a large sized device or package is mostly achieved by a multi-layered redistribution layer (RDL). Long-distance data transmission between the active components may suffer from serious signal attenuation and power consumption. To improve the efficiency of long-distance data transmission between the active components, optical waveguides may be used to connect the active components. However, a great number of waveguides arranged with the active components may undesirably increase the size of the device or package, particularly the size in an x-y plane.

### SUMMARY

In one or more arrangements, an electronic device includes a plurality of electronic components, a plurality of first waveguides, and a switch element. The first waveguides are disposed under the electronic components. The switch element is disposed under the electronic components and at an elevation different from the first waveguides, wherein the switch element is configured to optically connect a first one of the first waveguides to a second one of the first waveguides.

In one or more arrangements, an electronic device includes a first electronic component, a second electronic component, and a third electronic component at a substantially same elevation; a first optical channel configured to optically couple the first electronic component to the second electronic component; and a second optical channel configured to optically couple the first electronic component to the third electronic component, wherein the first optical channel and the second optical channel are at different elevations.

In one or more arrangements, an electronic device includes a first electronic component, a first waveguide, and a switch element. The first waveguide is under and optically coupled to the first electronic component. The switch element is under the first waveguide and includes a first vertical optical path and a first horizontal optical path, wherein the switch element is configured to switch between the first vertical optical path and the first horizontal optical path for transmitting an optical signal from the first waveguide.

### BRIEF DESCRIPTION OF THE DRAWINGS

Aspects of the present disclosure are better understood from the following detailed description when read with the accompanying drawings. It is noted that various features may not be drawn to scale, and the dimensions of the various features may be arbitrarily increased or reduced for clarity of discussion.

FIG. 1A is a cross-section of an electronic device in accordance with some arrangements of the present disclosure.

FIG. 1B is a prospective view of an electronic device in accordance with some arrangements of the present disclosure.

FIG. 2A is a cross-section of a portion of an electronic device in accordance with some arrangements of the present disclosure.

FIG. 2B is a cross-section of a portion of an electronic device in accordance with some arrangements of the present disclosure.

FIG. 2C is a cross-section of a portion of an electronic device in accordance with some arrangements of the present disclosure.

FIG. 2D is a cross-section of a portion of an electronic device in accordance with some arrangements of the present disclosure.

FIG. 2E is a cross-section of a portion of an electronic device in accordance with some arrangements of the present disclosure.

FIG. 3A is a cross-section of an electronic device in accordance with some arrangements of the present disclosure.

FIG. 3B is a cross-section of an electronic device in accordance with some arrangements of the present disclosure.

FIG. 4A, FIG. 4B, FIG. 4C, FIG. 4D, and FIG. 4E illustrate various stages of an exemplary method for manufacturing an electronic device in accordance with some embodiments of the present disclosure.

Common reference numerals are used throughout the drawings and the detailed description to indicate the same or similar elements. The present disclosure will be more apparent from the following detailed description taken in conjunction with the accompanying drawings.

### DETAILED DESCRIPTION

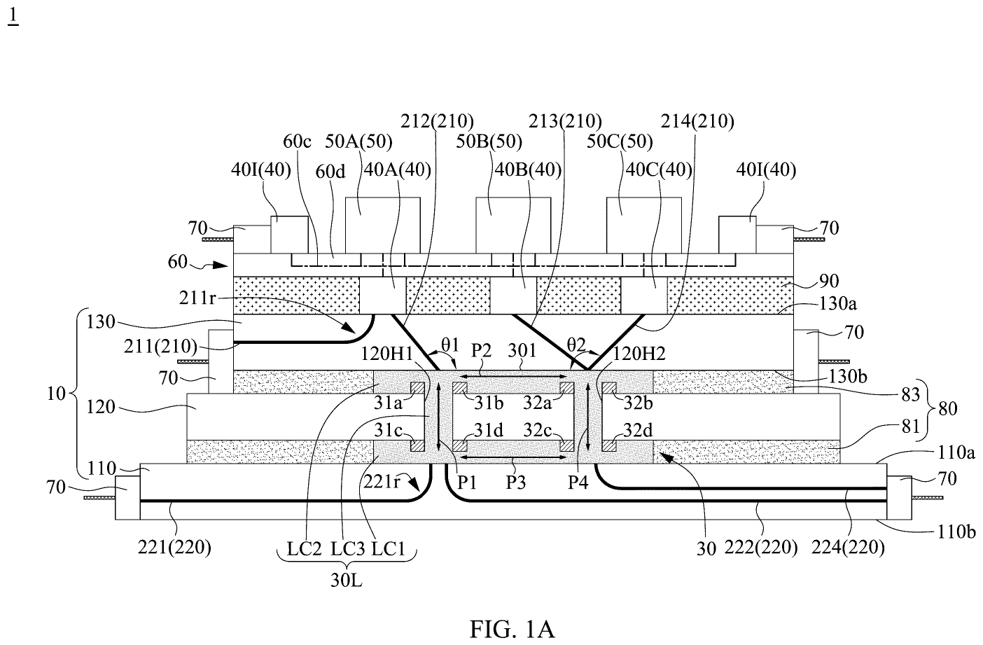

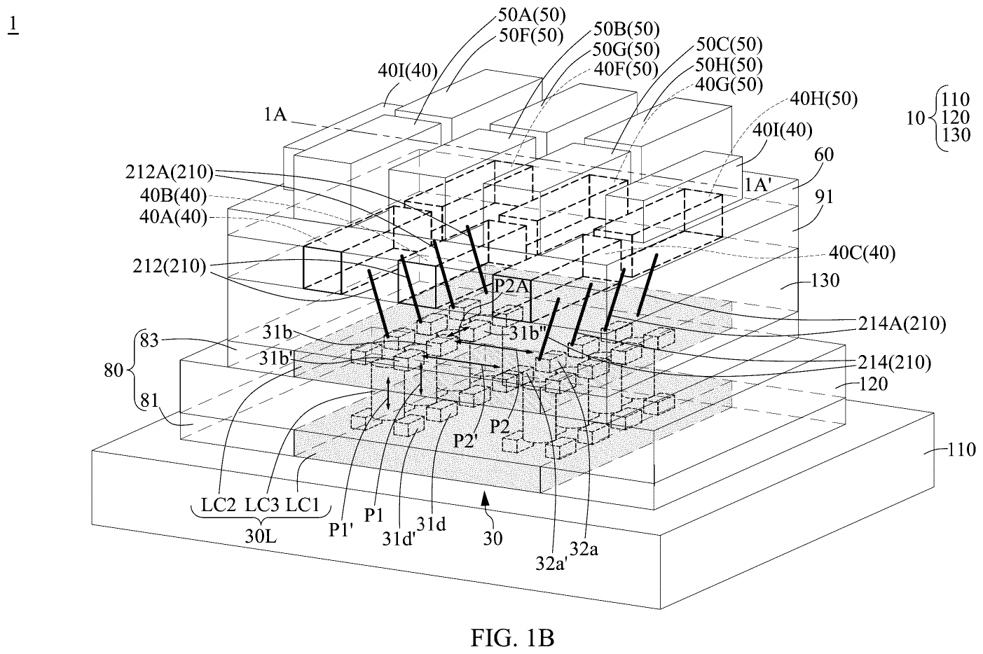

FIG. 1A is a cross-section of an electronic device 1 in accordance with some arrangements of the present disclosure. The electronic device 1 may include a substrate 10, waveguides 210 and 220, a switch element 30, optical engines 40, electronic components 50, a redistribution layer (RDL) 60, optical components 70, an adhesive element 80, and an encapsulant 90. In some arrangements, the electronic device 1 may be or include an optoelectronic package. The electronic device 1 may be or be included in a data center including a great number of processing components with relatively long distances between the processing components.

The substrate 10 may include substrate layers 110, 120, and 130. The substrate layers 110, 120, and 130 may be or include glass layers. The substrate layers 110, 120, and 130 may be adhered to each other by the adhesive element 80. The adhesive element 80 may include adhesive layers 81 and 83. In some arrangements, the substrate layers 110 are 120 are adhered to each other by the adhesive layer 81, and the substrate layers 120 are 130 are adhered to each other by the adhesive layer 83. The substrate layer 110 may include a top surface 110a facing the substrate layer 120 and a bottom surface 110b opposite to the top surface 110a. The substrate layer 130 may include a bottom surface 130b facing the substrate layer 120 and a top surface 130a opposite to the bottom surface 130b. In some arrangements, the substrate layers 110, 120, and 130 and the adhesive element 80 collectively define a space (or a cavity) for accommodating the switch element 30.

The waveguides 210 may be disposed under and optically coupled to the electronic components 50. The waveguides 210 may be embedded in the substrate layer 130. In some arrangements, the waveguides 210 may be or include laser modification lines formed by scanning a laser beam along predetermined locations in the substrate layer 130. The laser modification lines may have a refractive index higher than that of the substrate layer 130, such that the laser modification lines may serve as optical waveguides within the substrate layer 130 (or the glass layer). The waveguides 210 may include waveguides 211, 212, 213, and 214. The waveguides 211 and 212 may be optically coupled to the electronic component 50A, the waveguide 213 may be optically coupled to the electronic component 50B, and the waveguide 214 may be optically coupled to the electronic component 50C. The waveguide 211 may be optically coupled to the optical component 70. The waveguides 210 may be optical waveguides.

In some arrangements, at least one of the waveguides 210 (e.g. the waveguide 211) may define a curve 211r in a cross-sectional view perspective. In some arrangements, one or more of the waveguides 210 (e.g. the waveguides 212, 213, and 214) may define one or more slopes with respect to a top surface (e.g., a surface 301) of the switch element 30. In some arrangements, the waveguide 212 is configured to optically couple the electronic component 50A to the switch element 30, and the waveguide 212 and the bottom surface 130b of the substrate layer 130 define an angle θ1 greater than 90° and less than 180°. In some arrangements, the waveguide 213 is configured to optically couple the electronic component 50B to the switch element 30, and the waveguide 213 and the bottom surface 130b of the substrate layer 130 may define an angle greater than 90° and less than 180°. In some arrangements, the waveguide 214 is configured to optically couple the electronic component 50C to the switch element 30, and the waveguide 214 and the bottom surface 130b of the substrate layer 130 define an angle θ2 greater than 90° and less than 180°. In some arrangements, the waveguides 212, 213, and 214 are all inclined with respect to the bottom surface 130b of the substrate layer 130. The waveguides 212, 213, and 214 may be inclined by the same or different angles.

The waveguides 220 may be disposed under and optically coupled to the switch element 30. In some arrangements, the switch element 30 is configured to optically connect at least one of the waveguides 210 to at least one of the waveguides 220. The waveguides 220 may be embedded in the substrate layer 110. In some arrangements, the waveguides 220 may be or include laser modification lines formed by scanning a laser beam along predetermined locations in the substrate layer 110. The laser modification lines may have a refractive index higher than that of the substrate layer 110, such that the laser modification lines may serve as optical waveguides within the substrate layer 110 (or the glass layer). The waveguides 220 may include waveguides 221, 222, and 224. The waveguides 221, 222, and 224 may be optically coupled to the optical component 70. In some arrangements, one or more of the waveguides 220 (e.g. the waveguide 221, 222, and 224) may define one or more curves (e.g., a curve 221r) in a cross-sectional view perspective. The waveguides 220 may be optical waveguides.

The switch element 30 may be disposed under the electronic components 50. In some arrangements, the switch element 30 is at an elevation different from that of the waveguides 210 and that of the waveguides 220. The switch element 30 may be configured to optically connect at least two of the waveguides 210. In some arrangements, the switch element 30 is configured to optically connect the waveguide 212 to the waveguide 214. The switch element 30 may be configured to optically couple one or more of the waveguides 210 to one or more of the waveguides 220.

In some arrangements, the switch element 30 includes a liquid crystal material 30L. The liquid crystal material 30L may be configured to optically couple to the waveguides 210 and 220. In some arrangements, the switch element 30 includes a liquid crystal (LC) layer LC1, a LC layer LC2 stacked over the LC layer LC1, and a plurality of LC pillars LC3 connecting the LC layer LC1 and the LC layer LC2. In some arrangements, the LC pillars LC3 are disposed in through holes 120H1 and 120H2 of the substrate layer 120. In some arrangements, the switch element 30 includes electrodes 31a, 31b, 31c, 31d, 32a, 32b, 32c, and 32d, and selected ones of these electrodes are configured to be applied with a voltage to produce an electric field to generate selected optical path(s) within the switch element 30.

In some arrangements, the switch element 30 includes or defines a plurality of optical paths. The optical paths may include horizontal optical paths (e.g., optical paths P2 and P3) and vertical optical paths (e.g., optical paths P1 and P4). In some arrangements, the optical paths P1 and P4 pass through the LC pillars LC3, the optical path P2 passes through the LC layer LC2, and the optical path P3 passes through the LC layer LC1. In some arrangements, one or more of the waveguides 210 may contact the LC layer LC2. In some arrangements, one or more of the waveguides 220 may contact the LC layer LC1.

In some arrangements, the waveguide 212 is over the optical channel P2 and configured to optically couple the electronic component 50A to the optical channel P2. In some arrangements, the waveguide 212 and the optical channel P2 define an angle (i.e., the angle θ1) greater than 90° and less than 180°. In some arrangements, the waveguide 214 is over the optical channel P2 and configured to optically couple the optical channel P2 to the electronic component 50C. In some arrangements, the waveguide 214 and the optical channel P2 define an angle (i.e., the angle θ2) greater than 90° and less than 180°.

In some arrangements, the switch element 30 is configured to switch between the optical path P1 (or the vertical optical path) and the optical path P2 (or the horizontal optical path) for transmitting an optical signal from the waveguide 212. In some arrangements, the waveguide 212 is directly connected to the optical path P1 and the optical path P2. In some arrangements, the switch element 30 is configured to switch between the optical path P2 and the optical path P3 (through the optical path P1) for transmitting an optical signal from the optical engine 40A under the electronic component 50A. In some arrangements, the optical channel P1 extends substantially perpendicular to the optical channel P3 and is configured to optically couple the electronic component 50A to the optical channel P3. In some arrangements, the optical channel P2 at least partially vertically overlaps the optical channel P3. In some arrangements, the switch element 30 is configured to switch between the optical path P3 and the waveguide 220 (e.g., the waveguides 221 and 222) for transmitting the optical signal from the optical path P1. In some arrangements, the optical channel P1 is configured to optically couple to the optical components 70 through the waveguides 221, 222, and 223.

In some arrangements, the electronic components 50A, 50B, and 50C are at substantially the same elevation extending in a direction DR1, and the optical channels P2 and P3 are at different elevations and extending substantially parallel to the direction DR1. In some arrangements, the optical channel P1 extends substantially perpendicular to the optical channels P2 and P3. In some arrangements, the optical channel P2 is configured to optically couple the electronic component 50A to the electronic component 50C. In some arrangements, the optical channel P2 is configured to optically couple to the electronic component 50A through the waveguide 212 and optically couple to the electronic component 50C through the waveguide 214.

The optical engines 40 may include optical engines 40A, 40B, 40C, and 40I. In some arrangements, the optical engines 40A, 40B, and 40C are disposed under the electronic components 50. In some arrangements, each of the optical engines 40A, 40B, and 40C is disposed under a respective one of the electronic components 50A, 50B, and 50C. In some arrangements, each of the optical engines 40A, 40B, and 40C is configured to convert an electrical signal from each of the electronic components 50A, 50B, and 50C to an optical signal. In some arrangements, the optical engines 40A, 40B, and 40C are encapsulated by the encapsulant 90. In some arrangements, the optical engines 40I are configured to receive optical signals from the optical components 70 and convert the optical signals to electrical signals which are then transmitted to the RDL 60. In some arrangements, the optical engine 40 includes a photonic component, e.g., a photonic integrated circuit (PIC), and an electronic component, e.g., an electronic integrated circuit (EIC). The photonic component of the optical engine 40 may include a PIC, a laser diode, a receiver, a waveguide, a photodetector, a photodiode, a semiconductor optical amplifier (SOA), a grating coupler, a fiber coupling structure, an optical modulator (e.g., Mach-Zehnder modulator or microring modulator), or a combination thereof. The electronic element of the optical engine 40 may include a modulator driver (DRV), a trans-impedance amplifier (TIA), or a combination thereof.

The electronic components 50 may be disposed at substantially the same elevation and over the waveguides 210 and 220 and the switch element 30. The electronic components 50 may include processing components. In some arrangements, the electronic components 50 may independently include an ASIC, an FPGA, a GPU, or the like, or a combination thereof. In some arrangements, the electronic components 50 may independently include a processing core or a processing chiplet.

The RDL 60 may be disposed between the optical engines 40 and the electronic components 50. In some arrangements, the RDL 60 is configured to transmit at least an electrical signal between the optical engines 40 and the electronic components 50. In some arrangements, the RDL 60 includes a dielectric structure 60d and one or more conductive layers 60c in the dielectric structure 60d. The dielectric structure 60d may include one or more dielectric layers. In some arrangements, adjacent electronic components 50 may be electrically communicated to each other through the RDL 60.

The optical components 70 are disposed adjacent to the optical engines 40I, the waveguides 210, and the waveguides 220. The optical components 70 may be configured to receive optical signals and transmit the optical signals to the optical engines 40I, the waveguides 210, and the waveguides 220. In some arrangements, the optical component 70 is or includes an optical fiber array unit (FAU).

FIG. 1B is a prospective view of an electronic device 1 in accordance with some arrangements of the present disclosure. In some arrangements, FIG. 1A is a cross-section along a line 1A-1A′ in FIG. 1B. Please be noted that some elements/components are omitted in FIG. 1B for clarity.

In some arrangements, the switch element 30 includes optical paths extending in various directions to form a 3-dimensional (3-D) optical transmission network. For example, the switch element 30 includes at least optical paths P1, P1′, P2, P2′, and P2A. In some arrangements, the 3D optical transmission network includes the optical paths P1 and P1′, the optical paths P2 and P2′ extending substantially perpendicular to the optical paths P1 and P1′, and the optical path P2A extending substantially perpendicular to the optical paths P1, P1′, P2, and P2′. In some arrangements, the optical paths P1 and P1′ pass through the L pillars LC3, and the optical paths P2, P2′, and P2A pass through the LC layer LC2. In some arrangements, the switch element 30 is configured to switch between the optical path P1 (or the vertical optical path) and the optical path P2A (or the horizontal optical path) for transmitting an optical signal from the waveguide 210. In some arrangements, the optical path P2 and the optical path P2A are both horizontal optical paths and extend in substantially perpendicular directions.

In some arrangements, in addition to the above-mentioned optical paths P1, P1′, P2, P2′, and P2A, the switch element 30 further includes a plurality of additional horizontal optical paths passing through the LC layers LC1 and LC2 and a plurality of additional vertical optical paths passing through the LC pillars LC3 to form the 3-D optical transmission network. In some arrangements, the switch element 30 is configured to switch between a plurality of optical communications within the 3-D optical transmission network. For example, the switch element 30 is configured to switch between various optical communications between any two of the electronic components 50A, 50B, 50C, 50F, 50G, and 50H. The switch element 30 may be configured to switch between various optical communications between any two of the optical engines 40A, 40B, 40C, 40F, 40G, and 40H which are configured to convert an electrical signal from a respective one of the electronic components 50A, 50B, 50C, 50F, 50G, and 50H.

In some arrangements, a plurality of the optical signals from the optical engines 40 under the electronic component 50 may be transmitted through a plurality of waveguides and a plurality of optical channels to increase the transmission volume and thus increase the transmission speed.

In some arrangements, the electronic component 50A is optically coupled to the waveguides 212, the electronic component 50F is optically coupled to the waveguides 212A, the electronic component 50C is optically coupled to the waveguides 214, and the electronic component 50H is optically coupled to the waveguides 214A. In some arrangements, the waveguides 212 are configured to optically couple to the optical paths P1 and P1′. In some arrangements, the waveguides 212 are configured to optically couple to the optical paths P2 and P2′. The switch element 30 may be configured to switch between the optical paths P1 and P1′ and the optical paths P2 and P2′ for transmitting the optical signals from the optical engines 40A under the electronic component 50A through the waveguides 212.

In some arrangements, the waveguides 212 are under and optically coupled to the electronic component 50A. In some arrangements, the waveguides 212 are configured to transmit a plurality of the optical signals between the optical engine 40A under the electronic component 50A and the optical engine 40C under the electronic component 50C through the switch element 30. In some arrangements, the waveguides 214 are under and optically coupled to the electronic component 50C. In some arrangements, the waveguides 214 are configured to transmit the plurality of the optical signals between the optical engine 40C under the electronic component 50C and the switch element 30. In some arrangements, the waveguides 212 are configured to optically couple to the waveguides 214 through the optical paths P2 and P2′.

In some arrangements, an electric field may be produced by applying a voltage to the electrodes 31b and 31b′ and connecting the electrodes 31d and 31d′ to ground, and the optical paths P1 and P1′ are generated by the electric field. In some arrangements, an electric field may be produced by applying a voltage to the electrodes 31b and 31b′ and connecting the electrodes 32a and 32a′ to ground, and the optical paths P2 and P2′ are generated by the electric field. In some arrangements, an electric field may be produced by applying a voltage to the electrode 31b and connecting the electrode 31d″ to ground, and the optical path P2A is generated by the electric field.

In some cases when long distance communication between electronic components is required in a relatively large device, signal transmission by electrical paths (e.g., RDLs, fan-out structures, or the like) may suffer from large power loss and high latency. To solve the issue of large power loss, optical waveguides may be used for optically coupling the electronic components; however, a large number of optical waveguides are required due to a large number of the electronic components, and thus the device area (e.g., in x-y plane) is increased accordingly. In contrast, according to some arrangements of the present disclosure, with the design of the switch element 30 configured to switch optical paths for optically coupling to waveguides 210 and 220 at different elevations, optical transmissions between different pairs of electronic components can be realized by waveguides that are at different elevations and at least partially vertically overlapped each other. Therefore, the area (e.g., in x-y plane) occupied by the optical transmissions between different pairs of electronic components is reduced, and thus the device size can be significantly reduced.

In addition, according to some arrangements of the present disclosure, the waveguides 210 and 220 are formed by laser modification. The scanning path of a laser beam can extends in inclined paths rather in horizontal paths, and thus the waveguides 210 and 220 can be formed as inclined waveguides that optically couple the switch element 30 to an offset electronic component 50. Therefore, the area (e.g., in x-y plane) occupied by the waveguides 210 and 220 can be reduced, and thus the device size can be further reduced.

Moreover, according to some arrangements of the present disclosure, an optical signal from one optical engine under the respective one electronic component (e.g., the electronic component 50A) can be divided into a plurality of optical signals transmitted through a plurality of waveguides (e.g., the waveguides 212) and a plurality of optical channels (e.g., the optical paths P1 and P1′ or the optical paths P2, and P2′). Therefore, the transmission volume of the optical signal within a unit time can be increased, and thus the transmission speed is increased.

Furthermore, according to some arrangements of the present disclosure, the switch element 30 includes a 3-D optical transmission network including optical paths extending in various horizontal directions and vertical directions. As such, a large number of optical transmissions between various electronic components 50 can be generated by an applied voltage and/or an applied electric field to produce and switch between various combinations of the optical paths. Therefore, various optical transmissions between a large number of electronic components 50 can be realized by the switch element 30 having a relatively small volume and particularly a relatively small area in x-y plane.

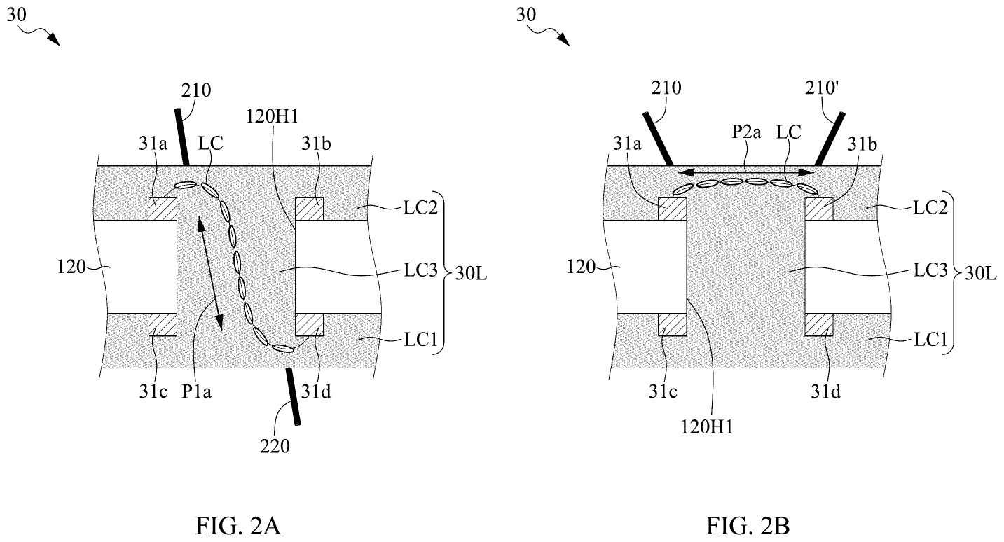

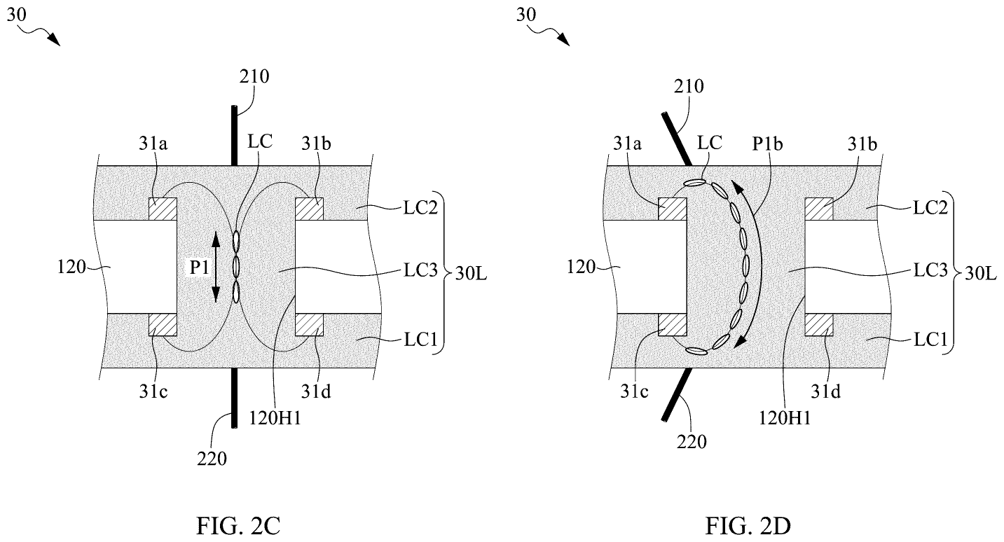

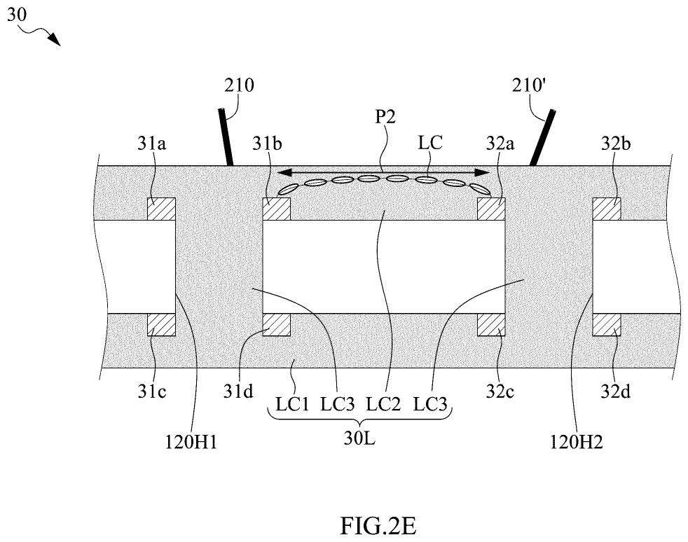

FIG. 2A is a cross-section of a portion of an electronic device in accordance with some arrangements of the present disclosure. In some arrangements, FIG. 2A is a cross-section of a portion of the electronic device 1 in FIG. 1A.

In some arrangements, the electrode 31d is connected to ground, and a voltage is applied to the electrode 31a to generate a voltage difference between the electrode 31a and 31d to produce an electric field, and long axes of liquid crystal molecules of the LC material 30L are arranged along the electric field line to generate an optical path Pla. In some arrangements, the electrodes 31b and 31c are not applied with a voltage. In some arrangements, the electrodes 31b and 31c are not connected to ground. In some arrangements, the electrodes 31b and 31c may be electrically isolated from the electrodes 31a and 31d. In some arrangements, the electrodes 31a and 31d are at opposite sides of the LC pillar LC3, and thus the optical path Pla is tilted. In some arrangements, the optical path Pla optically couples the waveguide 210 to the waveguide 220.

FIG. 2B is a cross-section of a portion of an electronic device in accordance with some arrangements of the present disclosure. In some arrangements, FIG. 2B is a cross-section of a portion of the electronic device 1 in FIG. 1A.

In some arrangements, the electrode 31b is connected to ground, and a voltage is applied to the electrode 31a to generate a voltage difference between the electrode 31a and 31b to produce an electric field, and long axes of liquid crystal molecules of the LC material 30L are arranged along the electric field line to generate an optical path P2a. In some arrangements, the electrodes 31c and 31d are not applied with a voltage. In some arrangements, the electrodes 31c and 31d are not connected to ground. In some arrangements, the electrodes 31c and 31d may be electrically isolated from the electrodes 31a and 31b. In some arrangements, the optical path P2a optically couples the waveguide 210 to the waveguide 210′.

FIG. 2C is a cross-section of a portion of an electronic device in accordance with some arrangements of the present disclosure. In some arrangements, FIG. 2C is a cross-section of a portion of the electronic device 1 in FIG. 1A.

In some arrangements, the electrodes 31c and 31d are connected to ground, and a voltage is applied to the electrodes 31a and 31b to generate a voltage difference between the electrodes 31a and 31b and the electrodes 31c and 31d to produce an electric field, and long axes of liquid crystal molecules of the LC material 30L are arranged along the electric field line to generate an optical path P1. In some arrangements, the optical path P1 optically couples the waveguide 210 to the waveguide 220.

FIG. 2D is a cross-section of a portion of an electronic device in accordance with some arrangements of the present disclosure. In some arrangements, FIG. 2D is a cross-section of a portion of the electronic device 1 in FIG. 1A.

In some arrangements, the electrode 31c is connected to ground, and a voltage is applied to the electrode 31a to generate a voltage difference between the electrode 31a and 31c to produce an electric field, and long axes of liquid crystal molecules of the LC material 30L are arranged along the electric field line to generate an optical path P1b. In some arrangements, the optical path P1b is curved along the electric field line. In some arrangements, the optical path P1b optically couples the waveguide 210 to the waveguide 220.

FIG. 2E is a cross-section of a portion of an electronic device in accordance with some arrangements of the present disclosure. In some arrangements, FIG. 2E is a cross-section of a portion of the electronic device 1 in FIG. 1A.

In some arrangements, the electrode 31b is connected to ground, and a voltage is applied to the electrode 32a to generate a voltage difference between the electrode 32a and 31b to produce an electric field, and long axes of liquid crystal molecules of the LC material 30L are arranged along the electric field line to generate an optical path P2. In some arrangements, the optical path P2 optically couples the waveguide 210 to the waveguide 210′.

In some arrangements, referring to FIGS. 2A-2E, the switch element 30 is configured to switch between various optical paths (e.g., the optical paths P1, Pla, P1b, P2, and P2a) for transmitting an optical signal by an applied voltage. In some arrangements, the switch element 30 is configured to switch between the optical paths (e.g., the optical paths P1, Pla, P1b, P2, and P2a) by an applied electric field. In some arrangements, the switch element 30 is configured to switch an optical signal between optical paths (e.g., the optical paths P1 and P2, the optical paths P1 and P2a, the optical paths P1b and P2, or the optical paths P1b and P2a) extending in substantially perpendicular directions. In some arrangements, the switch element 30 is configured to switch an optical signal between optical paths (e.g., the optical paths Pla and P2, the optical paths Pla and P2a) extending inclined with respect to each other. In some arrangements, the switch element 30 is configured to switch an optical signal between optical paths (e.g., the optical paths P2a and P2) extending in substantially perpendicular directions.

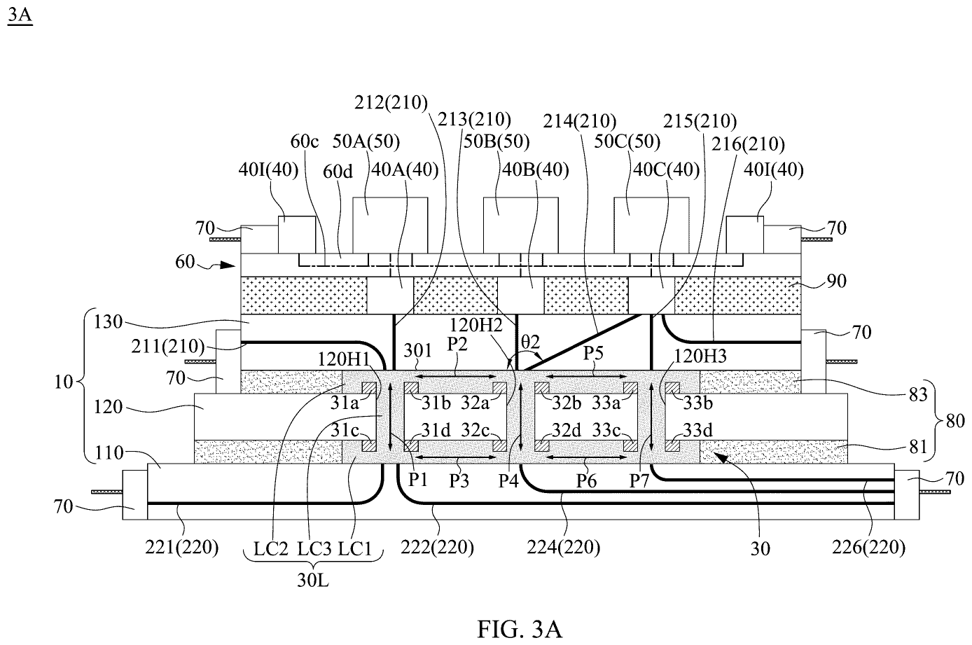

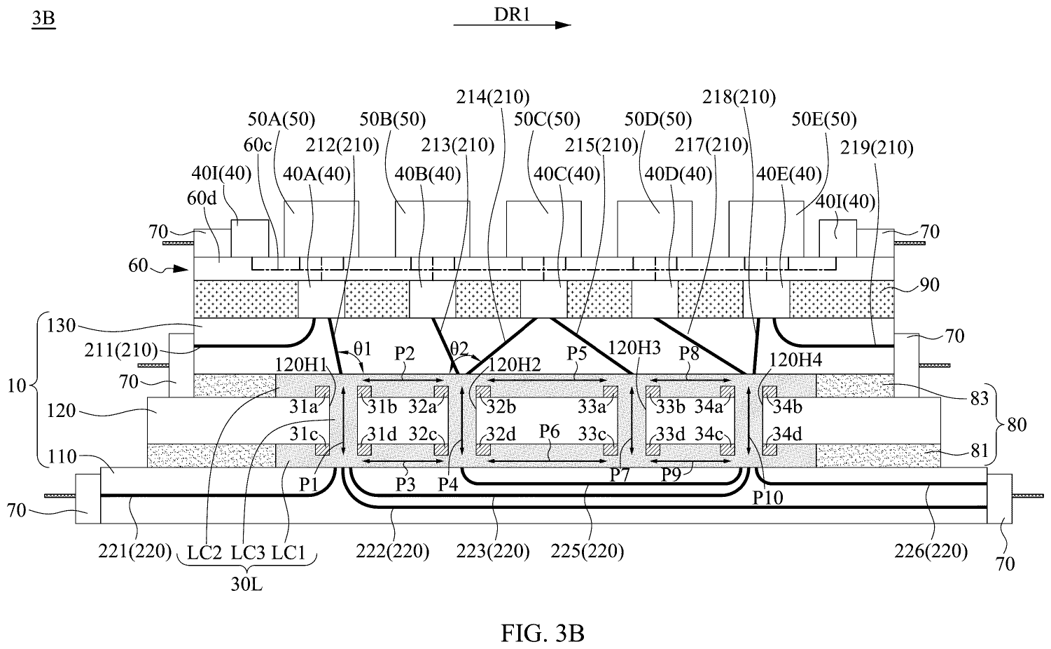

FIG. 3A is a cross-section of an electronic device 3A in accordance with some arrangements of the present disclosure. The electronic device 3A is similar to the electronic device 1 in FIG. 1A and FIG. 1B, and the differences therebetween are described as follows.

In some arrangements, the switch element 30 further includes electrodes 33a, 33b, 33c, and 33d for switching between optical paths P1, P2, P3, P4, P5, P6, and P7 by an applied voltage and/or by an applied electric field. In some arrangements, the waveguides 210 further include waveguides 215 and 216 for optically coupling to the electronic component 50C. In some arrangements, the waveguides 220 further includes a waveguide 226 for optically coupling to the optical paths P6 and P7.

FIG. 3B is a cross-section of an electronic device 3B in accordance with some arrangements of the present disclosure. The electronic device 3B is similar to the electronic device 1 in FIG. 1A and FIG. 1B, and the differences therebetween are described as follows.

In some arrangements, the switch element 30 further includes electrodes 34a, 34b, 34c, and 34d for switching between optical paths P1, P2, P3, P4, P5, P6, P7, P8, P9, and P10 by an applied voltage and/or by an applied electric field. In some arrangements, the waveguides 210 further include waveguides 217 and 218 for communicating the electronic components 50D and 50E by optical coupling. In some arrangements, the waveguides 220 further includes a waveguide 225 for optically coupling to the optical paths P9 and P10.

In some arrangements, the waveguide 225 is disposed under the switch element 30, and the electronic component 50A is communicated with the electronic component 50E through the waveguide 212, the switch element 30, and the waveguide 225 by optical coupling. In some arrangements, the optical channel P10 is substantially perpendicular to the optical channel P3 and configured to optically couple the optical channel P3 to the electronic component 50E. In some arrangements, the optical path P3 is optically coupled to the optical path P10 through the waveguide 225. In some arrangements, the waveguides 214 and 218 are over and extending inclined with respect to the optical channel P2, the waveguide 214 is configured to optically couple the optical channel P2 to the electronic component 50C, and the waveguide 218 is configured to optically couple the optical channel P3 to the electronic component 50E.

In some arrangements, the electronic components 50A, 50B, 50C, 50D, and 50E are at the same elevation in a direction DR1, and the optical channels P2 and P3 are at different elevations and extending substantially parallel to the direction DR1. In some arrangements, the optical channel P1 extends substantially perpendicular to the optical channels P2 and P3. In some arrangements, the optical channel P2 is configured to optically couple the electronic component 50A to the electronic component 50C. In some arrangements, the optical channel P2 is configured to optically couple to the electronic component 50A through the waveguide 212 and optically couple to the electronic component 50C through the waveguide 214. In some arrangements, the optical channel P3 is configured to optically couple the electronic component 50A to the electronic component 50E. In some arrangements, the optical channel P3 is configured to optically couple to the electronic component 50A through the waveguide 212 and the optical channel P1 and optically couple to the electronic component 50E through the waveguide 218, the optical channel P10, and the waveguide 225.

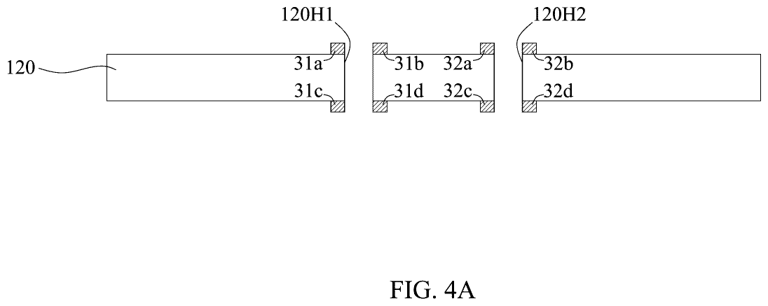

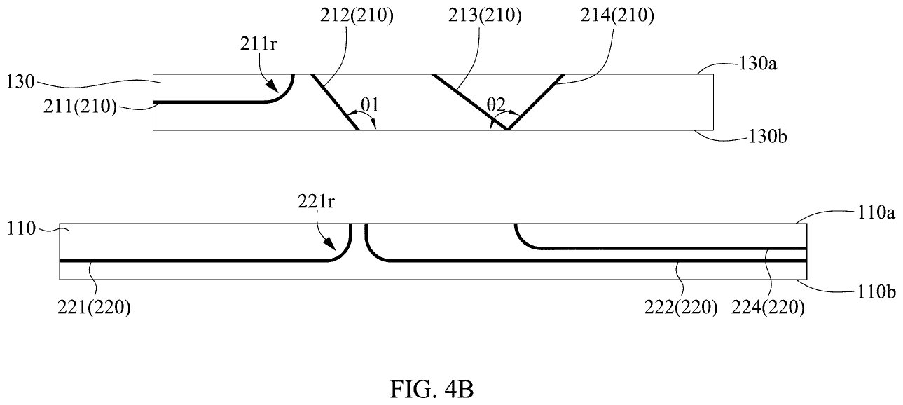

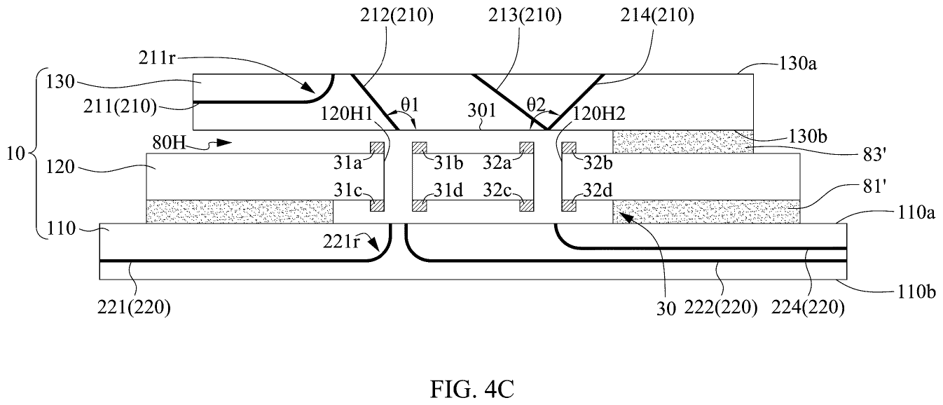

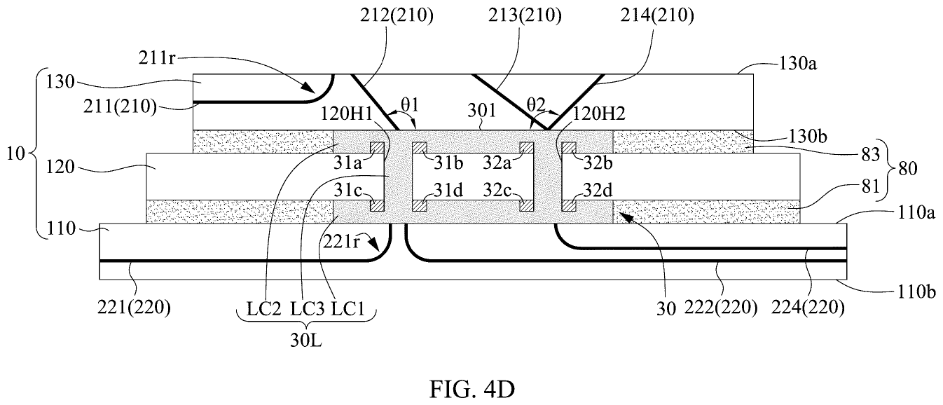

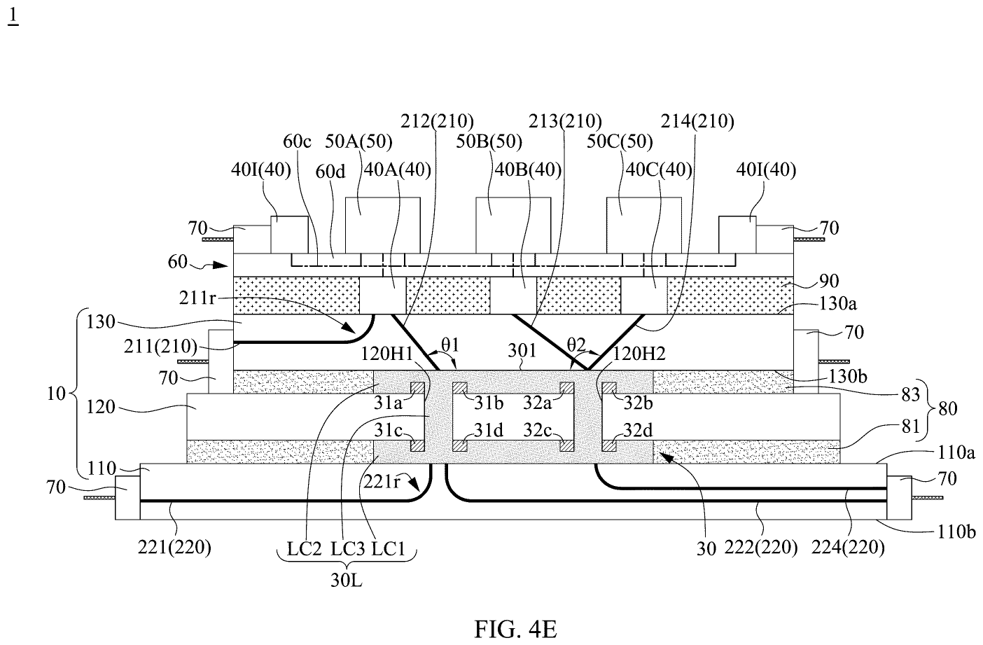

FIG. 4A, FIG. 4B, FIG. 4C, FIG. 4D, and FIG. 4E illustrate various stages of an exemplary method for manufacturing an electronic device 1 in accordance with some embodiments of the present disclosure.

Referring to FIG. 4A, a substrate layer 120 having through holes 120H1 and 120H2 may be provided, and electrodes 31a, 31b, 31c, 31d, 32a, 32b, 32c, and 32d may be formed on surfaces of the substrate layer 120. The substrate layer 120 may be a glass layer, and the through holes 120H1 and 120H2 may be formed by laser drilling or mechanical drilling.

Referring to FIG. 4B, substrate layers 110 and 130 may be provided, and waveguides 210 and 220 may be formed within the substrate layers 110 and 130, respectively. The substrate layers 110 and 130 may be glass layers. The waveguides 210 may be formed by scanning a laser beam along predetermined locations in the substrate layer 110 to form laser modification lines. The waveguides 220 may be formed by scanning a laser beam along predetermined locations in the substrate layer 130 to form laser modification lines. The laser modification lines may have a refractive index higher than that of the substrate layers 110 and 130, such that the laser modification lines may serve as optical waveguides within the substrate layers 110 and 130

Referring to FIG. 4C, the substrate layers 110, 120, and 130 may be stacked over each other to form a substrate 10, adhesive layers 81′ may be filled in a gap between the substrate layers 110 and 120, and adhesive layers 83′ may be filled in a gap between the substrate layers 120 and 130 to define a space or a cavity, and the adhesive layer 83′ has an opening 80H that connects the space or the cavity to an outside space.

Referring to FIG. 4D, a liquid crystal material 30L is filled in the space or the cavity, and then an adhesive material is filled in and seal the opening 80H to form the adhesive element 80 including the adhesive layers 81 and 83. The liquid crystal material 30L is then cured to form a switch element 30.

Referring to FIG. 4E, optical engines 40A, 40B, and 40C may be formed over the waveguides 210, an encapsulant 90 may be formed to encapsulate the optical engines 40A, 40B, and 40C, an RDL 60 may be formed over the optical engines 40A, 40B, and 40C, and electronic components 50, optical engines 40I, and optical components 70 may be formed over the substrate 10 and the RDL 60. As such, the electronic device 1 is formed.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to +10% of that numerical value, such as less than or equal to +5%, less than or equal to +4%, less than or equal to +3%, less than or equal to +2%, less than or equal to +1%, less than or equal to +0.5%, less than or equal to +0.1%, or less than or equal to +0.05%. For example, a first numerical value can be deemed to be “substantially” the same or equal to a second numerical value if the first numerical value is within a range of variation of less than or equal to +10% of the second numerical value, such as less than or equal to +5%, less than or equal to +4%, less than or equal to +3%, less than or equal to +2%, less than or equal to +1%, less than or equal to +0.5%, less than or equal to +0.1%, or less than or equal to +0.05%. For example, “substantially” perpendicular can refer to a range of angular variation relative to 90° that is less than or equal to +10°, such as less than or equal to +5°, less than or equal to +4°, less than or equal to +3°, less than or equal to +2°, less than or equal to +1°, less than or equal to +0.5°, less than or equal to +0.1°, or less than or equal to +0.05°.

Two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be substantially flat if a displacement between a highest point and a lowest point of the surface is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device, comprising:
a plurality of electronic components;
a plurality of first waveguides disposed under the electronic components; and
a switch element disposed under the electronic components and at an elevation different from the first waveguides, wherein the switch element is configured to optically connect a first one of the first waveguides to a second one of the first waveguides.

2. The electronic device as claimed in claim 1, wherein the plurality of electronic components comprise a first electronic component optically coupled to the switch element through the first one of the first waveguides.

3. The electronic device as claimed in claim 2, wherein the plurality of electronic components further comprise a second electronic component optically coupled to the first electronic component through the second one of the first waveguides and the switch element.

4. The electronic device as claimed in claim 1, wherein the switch element is configured to switch between optical paths for transmitting an optical signal by an applied voltage.

5. The electronic device as claimed in claim 4, wherein the switch element is configured to switch between the optical paths by an applied electric field.

6. The electronic device as claimed in claim 4, wherein the optical paths comprise a 3-dimensional (3-D) optical transmission network.

7. The electronic device as claimed in claim 4, wherein the switch element comprises a liquid crystal material configured to optically couple to the first waveguides.

8. The electronic device as claimed in claim 1, further comprising a second waveguide, wherein the switch element is disposed between the first waveguides and the second waveguide, a first one of the plurality of electronic components comprise a first electronic component and a second electronic component, and the first electronic component is communicated with the second electronic component by optical coupling through the first one of the first waveguides, the switch element, and the second waveguide.

9. The electronic device as claimed in claim 1, wherein the first one of the first waveguides defines a slope with respect to a top surface of the switch element.

10. The electronic device as claimed in claim 1, wherein at least a third one of the first waveguides defines a curve in a cross-sectional view perspective.

11. The electronic device as claimed in claim 1, further comprising:
a plurality of optical engines each disposed under a respective one of the electronic components; and
a redistribution layer (RDL) between the optical engines and the electronic components and configured to transmit at least an electrical signal between the optical engines and the electronic components.

12. An electronic device, comprising:
a first electronic component, a second electronic component, and a third electronic component at a substantially same elevation;
a first optical channel configured to optically couple the first electronic component to the second electronic component; and
a second optical channel configured to optically couple the first electronic component to the third electronic component, wherein the first optical channel and the second optical channel are at different elevations.

13. The electronic device as claimed in claim 12, further comprising a switch element defining the first optical channel and the second optical channel and configured to switch between the first optical channel and the second optical channel for transmitting an optical signal from an optical engine under the first electronic component.

14. The electronic device as claimed in claim 12, further comprising a third optical channel extending substantially perpendicular to the second optical channel and configured to optically couple an optical engine under the first electronic component to the second optical channel.

15. The electronic device as claimed in claim 14, further comprising a fourth optical channel substantially perpendicular to the second optical channel and configured to optically couple the second optical channel to the third electronic component.

16. The electronic device as claimed in claim 12, further comprising a first waveguide and a second waveguide over and extending inclined with respect to the first optical channel, wherein the first waveguide is configured to optically couple the first optical channel to the second electronic component, and the second waveguide is configured to optically couple the second optical channel to the third electronic component.

17. An electronic device, comprising:
a first electronic component;
a first waveguide under and optically coupled to the first electronic component; and
a switch element under the first waveguide and comprising a first vertical optical path and a first horizontal optical path, wherein the switch element is configured to switch between the first vertical optical path and the first horizontal optical path for transmitting an optical signal from the first waveguide.

18. The electronic device as claimed in claim 17, wherein the switch element further comprises a second horizontal optical path, and the switch element is configured to switch between the first vertical optical path and the second horizontal optical path for transmitting the optical signal from the first waveguide.

19. The electronic device as claimed in claim 18, wherein the first horizontal optical path and the second horizontal optical path extend in substantially perpendicular directions.

20. The electronic device as claimed in claim 17, wherein the switch element comprises a first liquid crystal (LC) layer, a second LC layer stacked over the first LC layer, and a plurality of LC pillars connecting the first LC layer and the second LC layer, the first horizontal optical path passes through the second LC layer, and the first vertical optical path passes through at least one of the LC pillars.
